(19) United States
(12) Patent Application Publication
(10) Pub. No.: US 2006/0100916 A1
(43) Pub. Date: May 11, 2006

(54) System, method, and software for convergence-based project planning

(75) Inventors: Brian M. Kennedy, Coppell, TX (US); Michael N. Kennedy, Anna, TX (US)

Correspondence Address: BAKER BOTTS L.L.P., 2001 ROSS AVENUE, SUITE 600, DALLAS, TX, 75201-2980, US

(73) Assignee: TARGETED CONVERGENCE CORPORATION

(21) Appl. No.: 11/270,860

(22) Filed: Nov. 9, 2005

Related U.S. Application Data
(60) Provisional application No. 60/627,520, filed on Nov. 11, 2004.

(51) Int. Cl. G06F 9/44

(52) U.S. Cl. 705/7

(57) ABSTRACT

A product development technique is provided that enables a user to define a product family design structure. The product family design structure includes a number of customer concerns, a number of physical properties associated with components of the product, and a number of relation models. Each customer concern is associated with at least one physical property via at least one mathematical relationship defined in at least one of the relation models. The technique also enables the user to define one or more product development projects based on the product family design structure, where the one or more product development projects vary from the product family design structure according to one or more overrides specified by the user for the values associated with one or more of the customer concerns, relation models, and/or physical properties defined in the product family design structure. The technique further enables the user to input a value associated with one or more of the physical properties of at least one of the product development projects and to calculate, using one or more of the relation models, the effect of the inputted value associated with the one or more physical properties on one or more of the customer concerns of the product development project.

### CROSS REFERENCE TO RELATED APPLICATIONS

This application claims the benefit of U.S. Provisional Application No. 60/627,520, filed Nov. 11, 2004 by Brian M. Kennedy et al., and entitled “System, Method, and Software for Convergence-Based Project Planning.”

This application also claims the benefit of the following application which is also incorporated by reference herein: U.S. application Ser. No. 10/970,745, filed Oct. 20, 2004, by Brian M. Kennedy et al., and entitled “System and Method for Relation-Based Product Development.”

### TECHNICAL FIELD

This invention relates in general to the fields of business management and project planning. More particularly, the present invention relates to project planning for product design and development efforts. Specifically, the present invention relates to a system and method for convergence-based project planning for product development efforts.

### BACKGROUND

The vast majority of product development efforts in the world are planned and managed very similarly, and have similar results. Most such projects are micro-managed in tremendous detail. Engineers and managers spend a significant amount of time simply managing the project, responding to planning reviews, and explaining delays or resource issues. That is all time that could be spent on the central tasks of developing the product. Further, although managed in such detail, the projects are typically out-of-control in the sense that schedule surprises are frequent and significant. Milestone dates are often missed. Significant, unplanned rework is so much the norm that projects often schedule in “pad time” for such unknown tasks.

In many product development efforts, assemblies (products) are broken down into subassemblies, and subassemblies into their respective sub-subassemblies. Then for each subassembly, a set of tasks are defined that must be completed by certain dates in order to complete that subassembly in time to support the schedule for the larger assemblies of which it is a part. Those larger assemblies have their own set of tasks, some to be completed before the subassemblies' tasks begin, some while the subassemblies are being worked, and some after the subassemblies' tasks are complete.

Managing this process involves carefully monitoring the completion of each task. The focus is not so much on the quality of what was done in each task, but rather on its timely completion. Often tasks are seemingly completed on time, but at the compromise of the quality—compromises that will cause inevitable delays in later tasks, or worse. For example, when the subassemblies are assembled together and under-perform, the low quality subassemblies often cause a necessary re-design of one or more subassemblies.

Furthermore, it is rare that tasks are scheduled in for broader learning in anticipation of future projects that could benefit from that learning. And even if such tasks were scheduled in, they would be purely incidental to the current project. Thus, they would be the first tasks to be removed when schedules begin to get strained.

Moreover, the tasks tend to be handed down from above and managed from above. However, the best solution to the trade-off between the time spent and the quality of the result can only be made at the lowest level, by the engineers. There is no fall-back—if the subsystem ends up unable to complete by the milestone, then the milestone must be pushed back.

The above issues and other problems plague current product development methods. For example, the critical path method is a method of task-based project management that focuses on the longest sequence of tasks with specified duration on the basis that the longest path will determine the overall length of the project. This method suffers from an extreme focus on task durations that are very difficult to estimate accurately. Success tends to be measured by accuracy of those difficult estimates.

The critical chain method is an alternative to critical path method, but is a similar task-based project management method. It attempts to reduce the problematic aspects of critical path method, by recognizing that there will be variability and that it is possible to plan for that variability in an effective way. Buffers are introduced into the critical chain to protect it from the inevitable missed estimates. The non-critical tasks are then scheduled around the critical chain, maintaining adequate buffers such that their variability is never allowed to impact the critical chain. While offering an improvement over the critical path method, this method still suffers from premature decisions. When the critical chain is defined, many key design decisions must be made or predicted, often without adequate knowledge. If premature decisions end up being wrong, then an iteration is forced. The critical chain method attempts to manage this with significantly large buffers, but does nothing to help reorder the decisions to avoid the premature decisions in the first place.

The phase gate and stage gate methods were developed specifically for managing product development projects at the highest levels. The methods are designed to ensure that the product specifications are adequately detailed and adequately reviewed before projects are allowed to proceed. This provides an added level of control to help improve the premature decisions, but does nothing to avoid those premature decisions.

### SUMMARY

In accordance with the present invention, a system and method for convergence-based project planning for product development efforts are provided that substantially eliminate or reduce the disadvantages and problems associated with the previously developed systems and methods.

According to one aspect of the present invention, a product development technique is provided that enables a user to define a product family design structure. The product family design structure includes a number of customer concerns, a number of physical properties associated with components of the product, and a number of relation models. Each customer concern is associated with at least one physical property via at least one mathematical relationship defined in at least one of the relation models. The technique also enables the user to define one or more product development projects based on the product family design structure, where the one or more product development projects vary from the product family design structure according to one or more overrides specified by the user for the values associated with one or more of the customer concerns, relation models, and/or physical properties defined in the product family design structure. The technique further enables the user to input a value associated with one or more of the physical properties of at least one of the product development projects and to calculate, using one or more of the relation models, the effect of the inputted value associated with the one or more physical properties on one or more of the customer concerns of the product development project.

Particular embodiments of the present invention may provide some or all of the following advantages. For example, certain embodiments provide a software system that allows one or more development projects to be represented as project-specific variations of a relation-based representation of a product family design, where the project-specific variations can include project-specific overrides for the targets, ranges, and profit models. Particular embodiments further allow the project-specific variations of the relation-based representation to be pruned down, eliminating attributes and relations that are irrelevant in the particular project due to looser customer concerns, options and alternatives that will not be considered, or options or ranges that are inferior to other alternatives or options. Certain embodiments further allow the project-specific variation of the relation-based representation to additionally represent project planning and management data including sub-projects, tasks, and resources, where the sub-projects and tasks have planned completion dates, resource assignments, durations and/or resource usages, and specific goals.

Particular embodiments manage a set of tasks to generate the knowledge necessary to enable a particular design decision to be made. Such embodiments enable team members to understand progress towards that decision point as knowledge is gained, allows alternative tasks to be terminated as they are rendered unnecessary by other tasks' results, and allows resources to be re-allocated based upon that progress in order to maximize the knowledge available at the point that the decision must be made.

Furthermore, certain embodiments are able to identify “knowledge gaps” where the calculated ranges for a particular product design would require you to use relations at a confidence level of less than one hundred percent. In such a case, the recommended approach is to perform testing and analysis to raise the confidence level in the targeted and propagated ranges to one hundred percent, such that there is no knowledge gap that the design depends upon. Particular embodiments may highlight such knowledge gaps, so that as part of completing a project design structure, the associated engineers can do the necessary testing to fill out the particular relations with data with a higher confidence level.

Certain embodiments allow the project planners to understand the potential profitability gains of the knowledge being learned by a task and relate that directly to the costs being incurred to generate that knowledge. In that way, appropriate profit-based decisions may be made regarding development resource allocations.

Particular embodiments allow development projects to be managed in terms of milestones which represent key decision points which are dependent upon certain sub-projects that provide the knowledge necessary to make the decisions being represented. Furthermore, development projects may not only be managed in terms of milestones as described, but certain embodiments may further allow the progress towards the milestone to be computed in terms of the percentage of the needed knowledge that has been learned and/or the risk remaining in obtaining the remaining knowledge. Furthermore, particular embodiments allow the dependent sub-projects to be assigned resources according to the rate of knowledge generation versus the milestone date, the costs being incurred by the sub-projects, the potential costs saved by learning the knowledge being generated by the sub-projects, and the risk remaining in the sub-projects.

### BRIEF DESCRIPTION OF THE DRAWINGS

FIG. 1 illustrates a generic product design structure represented in terms of mathematical relations between various product attributes, in accordance with one embodiment of the present invention;

FIG. 2 illustrates a relation-based representation of a product family and products included in the product family according to one embodiment of the present invention;

FIG. 3 illustrates example instances of a product family structure and product structure according to one embodiment of the present invention;

FIG. 4 illustrates an example product structure of FIG. 3 with additional project-specific constructs according to one embodiment of the present invention;

FIG. 5 illustrates an example product structure with alternative sub-projects according to one embodiment of the present invention;

FIG. 6 illustrates example sub-projects and associated milestones of the example project structure illustrated in FIG. 5; and

FIG. 7 illustrates example sub-projects and an associated milestone of the example project structure illustrated in FIG. 5.

### DETAILED DESCRIPTION

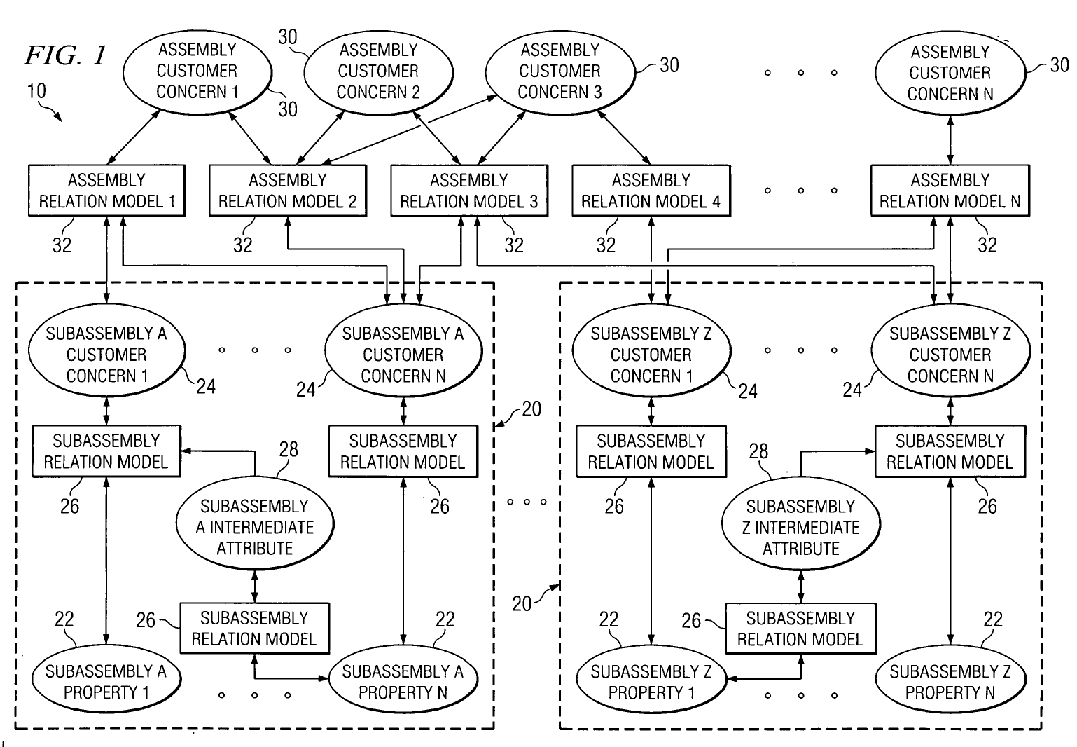

FIG. 1 illustrates a generic product design structure 10 represented in terms of mathematical relations between various product attributes, in accordance with one embodiment of the present invention. The product attributes include both the properties associated with the physical components that comprise the product (“physical properties”) and the product characteristics (resulting from the selection of particular physical properties) with which a customer or other entity for which the product is being made is concerned (“customer concerns”). Structure 10 represents the design of a product (“assembly”) that includes multiple subassemblies 20. Although not illustrated, each subassembly 20 may also include any suitable number of sub-subassemblies, each sub-subassembly may be further decomposed into sub-sub-subassemblies, and so on.

In the illustrated example, each subassembly 20 includes a number of subassembly physical properties 22. Each property 22 may be mathematically related to one or more customer concerns 24 of the subassembly 20. In other words, the selection of a physical property 22 has an effect on one or more customer concerns 24 of the subassembly 20 that can be represented mathematically. Such mathematical representations between physical properties 22 and subassembly customer concerns 24 are contained in a number subassembly relation models 26. Each relation model 26 thus defines the relationship between one or more physical properties 22 and one or more subassembly customer concerns 24.

Furthermore, each subassembly 20 may include one or more intermediate attributes 28. A physical property 22 may be directly related to a subassembly customer concern 24 and/or it may be related to a subassembly customer concern 24 through one or more intermediate attributes 28. Therefore, particular relation models 26 may define the relationship between a physical property 22 and an intermediate attribute 28, and particular relation models 26 may define the relationship between an intermediate attribute 28 and a subassembly customer concern 24. Although FIG. 1, illustrates example relationships between a particular number of physical properties 22, intermediate attributes 28, and subassembly customer concerns 24, it should be understood that any suitable number of and any appropriate relationships between these components may be implemented.

Structure 10 also includes one or more assembly customer concerns 30. Each assembly customer concern is mathematically related to one or more subassembly customer concerns 24. Such mathematical representations between assembly customer concerns 30 and subassembly customer concerns 24 are contained in a number of assembly relation models 32. Each relation model 32 thus defines the relationship between one or more assembly customer concerns 30 and one or more subassembly customer concerns 24.

Using structure 10 or a similarly-defined product design structure, a product design engineer can focus on selecting physical properties to achieve particular assembly and subassembly customer concerns (again, which represent what the customer or user is concerned with when selecting a particular product). Furthermore, the design engineer can far more easily experiment at the assembly level, juggling different physical properties to find acceptable trade-offs. Many mathematical analyses can be performed to determine concrete information for the design engineer in identifying optimal physical property combinations. Finally, when a product is decomposed as in structure 10, it becomes much easier for engineers to record the knowledge that they learn during a project in a form that will be usable in conjunction with later projects.

In particular embodiments, a product design structure, such as structure 10, and its various components may be stored as software in a computer-readable medium accessible by one or more computers. This software and the associated computers used to execute and store the software form a product design system. Engineers or other individuals associated with the design of the product with which the structure is associated may access the components of the structure using the system so that the engineers may view and modify information relating to the attributes (customer concerns, properties, intermediate attributes) and/or relation models of the structure. For example, an engineer may construct a relation model associating a property with a customer concern. Each of these relation models (including the target values, ranges and profit models described below that are associated with the relation models) are mathematical relations of one or more dimensions. To specify mathematical relations, the design engineer may input mathematical formulae or may provide a set of values from which a formula can be derived via numerous different and well-known techniques (such as interpolation, linear regression, etc.). In particular embodiments, the mathematical relations may be specified imprecisely, reflecting only the general shape of the relation (e.g., increasing linearly), but not the precise numeric values. Such imprecise specifications allow engineers to express learned “rules of thumb” or other rough relationships and have the system able to perform rough-cut analyses and propagations to provide a level of insight to the engineers prior to the testing, experimentation, or analyses needed to specify the relations more precisely.

After entering a relation model, particular parameters associated with a property or other attribute with which the relation model is associated can then be selected and the effect on the customer concern or other attribute can be displayed. Further, certain embodiments may enable sophisticated search tools that allow an engineer to express desired values for attributes (whether customer concerns, physical properties, or intermediate attributes), and find any relations (through time) that support those values. For example, the system may search through all relation models and identify the relation models that match user-specified criteria based on the nature of the mathematical relationship and/or the nature of the values being related by the mathematical relationship. Any suitable user interfaces may be used to enable the engineer to enter and view information in the manner described above.

Given such relation-based development as described in conjunction with FIG. 1 and in U.S. application Ser. No. 10/970,745, filed Oct. 20, 2004 and entitled “System and Method for Relation-Based Product Development” (which is incorporated herein by reference), which enables the ongoing generation of knowledge and the corresponding ability to make product design decisions based on that knowledge, an opportunity emerges to manage product development very differently. Although relation-based development can be performed in conjunction with traditional product development processes, particular embodiments the present invention provide a superior approach to project planning and management that leverages the underlying knowledge embodied in the relations being used. This superior approach does not suffer the many disadvantages inherent to traditional product development methods.

The representation of a product design as described in conjunction with FIG. 1 allows the knowledge learned during product development to be captured in a way that can be easily reused in future product development efforts. The knowledge learned in a particular development project can be captured in this way, and then form the basis for the next development project on a similar product (on a product in the same product family). When managing such a development project, particularly when needing to manage multiple such projects, it becomes useful to represent the project explicitly, separate from (but related to) the knowledge captured in previous projects.

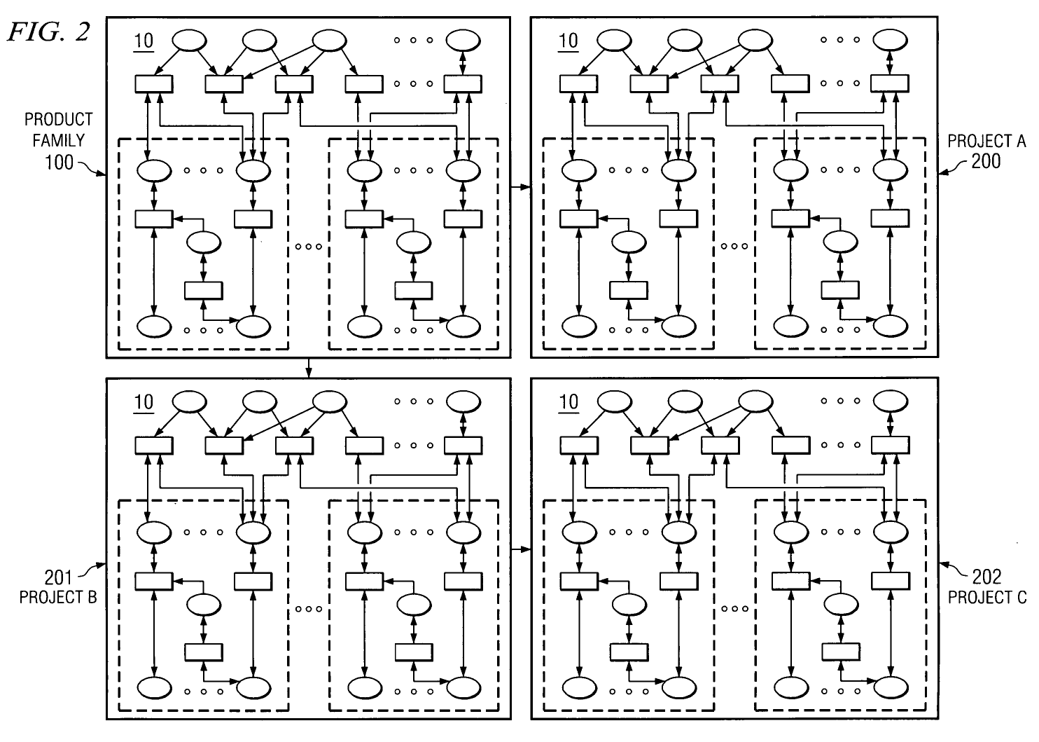

FIG. 2 illustrates a relation-based representation of a product family and associated product development projects included in the product family according to one embodiment of the present invention. The relation-based representation includes a product family design structure 100 which generically represents all of the product development projects in the product family. Separate Projects A, B, and C (denoted as 200, 201, and 203, respectively) can then be created based on product family structure 100. For example, Projects A and B are in the illustrated example are both based off of product family structure 100, whereas Project C is based off of Project B. Thus, Project A and B structures 200 and 201 default to the values given by product family structure 100, and then users are allowed to modify one or more values of the Project A and/or B structures 200 and 201 as appropriate given those particular projects. The Project C structure 202 defaults to the values given by Project B (which are based on the values of product family structure 100, but which may be modified as mentioned above). Certain values of the Project C structure 202 may then be modified as appropriate for that project. Thus, in each project structure, specific values can be overridden (set differently than the project structure or product family structure that the project structure is based upon.

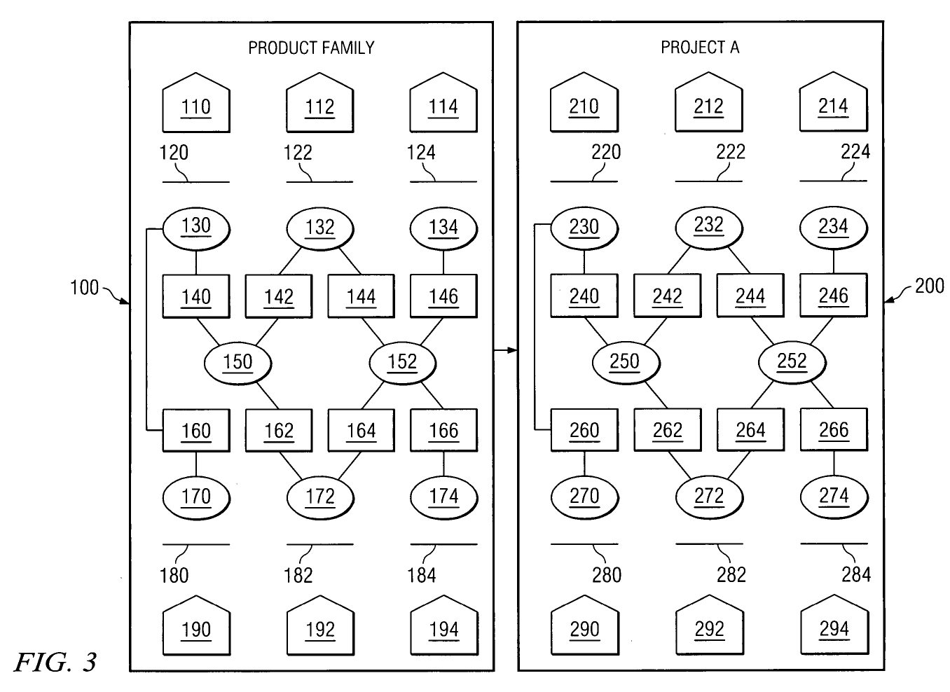

As an example, FIG. 3 illustrates example instances of product family structure 100 and Project A structure 200 according to one embodiment of the present invention. As can be seen, the general structure of the product family structure 100 and the Project A structure 200 are similar. However, as described above, certain values set in the product family structure 100 may be overridden or modified in the Project A structure 200. For examples, the values associated with project targets, ranges and profit models (as described in U.S. application Ser. No. 10/970,745) may be overridden. As examples only, project targets and ranges of Project A structure 200 indicated at 220, 222, and 280 may be overridden for the product family targets and ranges 120, 122, and 180, respectively. Furthermore, the Project A profit models 210, 214, 290, and 292 may be overrides for the product family profit models 110, 114, 190, and 192, respectively.

The modification of the different targets and ranges may necessitate use of ranges in the relations that are at a lesser confidence level than those in the product family model at the time of modification. For example, a greater target for 120 may necessitate using a portion of the relation 140 that is currently not populated, or populated with interpolated data that has not been tested. This may be referred to as a “knowledge gap” (where the propagated ranges for a particular design would require you to use relations at a confidence level of less than one hundred percent). In such a case, the recommended approach is to perform testing and analysis to raise the confidence level in the targeted and propagated ranges to one hundred percent, such that there is no knowledge gap that the design depends upon. The system may highlight such knowledge gaps, so that as part of completing this project structure 200, the engineers can do the necessary testing to fill out the particular relations with data with a higher confidence level.

Given that a typical project will have numerous such engineering efforts that must be performed to fill out all the relations needed in order to make decisions confidently, managing the project can benefit from additional project-specific constructs.

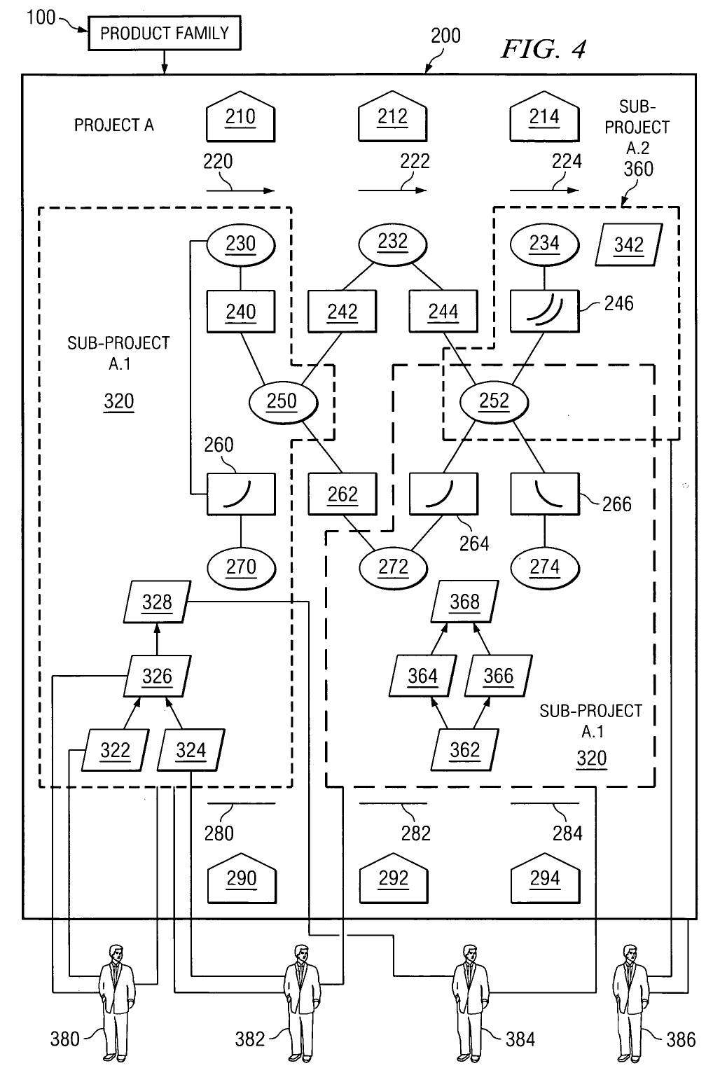

Accordingly, FIG. 4 depicts project structure 200 of FIG. 3, with the addition of sub-projects (320, 340, and 360), tasks (322, 324, 326, 328, 342, 362, 364, 366, and 368), and resources (380, 382, 384, and 386). The sub-projects represent a subset of the overall project with a specific planned completion date, specific assigned resources, a duration and/or resource usage, and specific goals (either certain knowledge to be ascertained or certain decisions to be made or both). As an example, the goals for sub-project 320 may be to perform the necessary testing on relation 260 to determine with higher confidence the curve in the higher range that is required by the project-specific targets 220. As another example, the goals for sub-project 340 may be to similarly satisfy a higher target 224, but in this example they may be looking at a different technological approach or innovation that would allow the curve in relation 246 to be shifted dramatically upward. In supporting that, for example, there may be new assumptions on relations 264 and 266 that demand re-testing to have confidence in the effects that properties 272 and 274 will have on attribute 252, given the new assumptions required for the innovation being explored in sub-project 340. To test the new assumptions on relations 264 and 266, sub-project 360 is launched. Note that sub-projects may overlap; and sub-projects may be nested within other sub-projects, forming effective sub-sub-projects.

Further, associated with each sub-project may be zero or more tasks that must be completed in order to complete the sub-project. The purpose of the associated tasks is to support traditional project planning approaches (such as Microsoft Project™ or the critical chain method) of task-based planning as desired within sub-projects. Each task may also have planned completion dates, assigned resources, a duration and/or resource usage, and specific goals. A best practice representation might associate with each sub-project one “master task” that can have sub-tasks. In that way, only the task structure need hold the planned completion dates, assigned resources, a duration and/or resource usage, and specific goals.

Resources will typically represent engineers or designers, but may also represent development teams, computer systems, testing equipment, or any other resources that need to be utilized (and thus scheduled) to complete tasks or sub-projects. For example, as illustrated in FIG. 4, resources 380 and 382 are assigned to sub-project 320, resources 382 and 384 are assigned to sub-project 360, and resource 386 is assigned to sub-project 340 as well as the overall project 200. Furthermore, tasks 322, 324, 326, and 328 are to be completed to complete sub-project 320, task 342 is to be completed to complete sub-project 340, and tasks 362, 364, 366, and 368 are to be completed to complete sub-project 360. The tasks have their own precedence relationships, as in traditional project planning. As an example, both tasks 322 and 324 may need to be completed prior to task 326 beginning, which in turn may need to be completed prior to task 328 beginning. All traditional task-based project-planning functionality could be applied here, though there is no attempt to illustrate all of that functionality. FIG. 4 does depict a variety of resource assignments to the tasks.

Beyond allowing project-specific knowledge, the project representation allows project planning and management structures to be represented, manipulated, and utilized for managing the projects. In addition to the planned completion dates, assigned resources, duration and/or resource usage, and goals, the tasks and/or sub-projects may also have a representation for the current status (e.g., percentage complete, percentage behind schedule, percentage risk in missing the planned dates, percentage risk in not achieving the goals, etc.). The system may further be capable of computing such status measurements based on the targets and ranges, the original data in the relation, and the current data in the relation. In that way, progress can be measured based on the acquired knowledge rather than based on time spent or engineer estimates of time-to-complete, though the latter two could also be supported by the system. Further, such status information may be captured by the system over time for multiple projects, providing knowledge regarding the rate of learning in certain situations. That knowledge, which can be represented as relations, can then be leveraged to build better plans in the future (for example, they can be used to base expectations for rates of learning in future projects) or to better manage progress against plans.

Note that resources and time may not need to be planned for much of a product knowledge structure. For example, the relations 242, 244, and 262 may be adequately confident in the necessary range that nothing more needs to be learned for this specific project. Thus, no sub-project or tasks may be created for those. The system should be capable of computing where existing knowledge is adequate and where it is not, and thus where sub-projects are needed to fill in that knowledge. However, the exact structure of the sub-projects will be designed according to project management needs. For example, the sub-projects 340 and 360 could have been organized as a single sub-project.

Note further that some customer concerns for the product family may not be concerns at all for a specific project. In that case, the target and range for that customer concern may be set to infinite. Based on that, the system should be capable of computing what portions of the relation-based product design representation are completely adequate (or essentially unneeded) for the specific project, and simplify the representation accordingly. The engineers need not be bothered with irrelevant structures and knowledge. For example, if the customer concern 232 is not of concern to the particular customers this particular project structure 200 is targeting, such that the range for range 222 is infinite, then the system could actually remove elements 212, 222, 232, 242, and 244 entirely from the project structure 200 (without affecting the product family structure 100), thereby simplifying the project structure 200 for the benefit of the engineers involved. Intermediate attributes 250 and 252 would not be able to be removed in this example because they also affect customer concerns that are relevant for this project 200.

Projects are often built prior to learning particular knowledge related to the project. In such situations, it is important to be able to represent numerous alternatives that need to be explored, tested, and the corresponding knowledge captured. Some of those alternatives may fail to generate any knowledge, some may fail to generate the desired knowledge (you may learn that something is not possible rather than learning that it is possible), and some may generate the knowledge that is ultimately leveraged in the further development of the product. By launching and managing several alternatives, a project can increase the likelihood that at least one workable alternative will be developed while at the same time increasing the likelihood that a more innovative and successful alternative may be found.

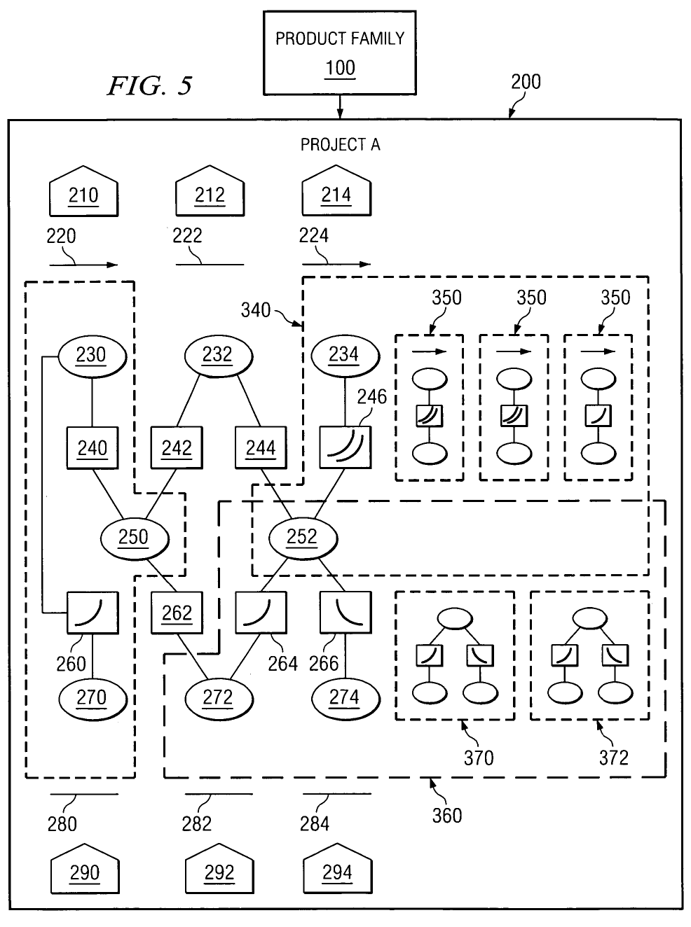

FIG. 5 shows the project structure 200 illustrated in FIG. 4, with sub-project 340 being broken down into three alternative sub-projects 350, 352, and 354 (furthermore, the tasks of FIG. 4 are removed for sake of simplicity). As an example only, alternative sub-projects 350 and 352 may represent two different new technologies or innovations that are being examined to try to move the curve of relation 246 significantly upward. In this example, alternative sub-project 354 may represent the fall-back alternative of using the past approach (although optimized as much as possible).

To support alternative sub-project 354, nothing need be done in sub-project 360, as the relations are already known with those assumptions. But for the technology assumptions of either alternative sub-projects 350 or 352, new testing may need to be done in sub-project 360. Thus, to support alternative sub-projects 350 or 352, alternative sub-projects 370 and 372 may be launched to test the corresponding assumptions of alternative sub-projects 350 or 352, respectively, on relations 264 and 266 (as an example).

Note that, like any sub-project, the alternative sub-projects can be based off a corresponding sub-project in a “parent” structure (either a product family structure or another project structure, as illustrated in FIG. 2), allowing the targets, ranges, profit models, and relations to default to that “parent” sub-project's targets, ranges, profit models, and relations (but also allow these values to be overridden). In this way, each of the alternative sub-projects may have different targets and profit models, corresponding to the different project assumptions and goals.

The system will be able to analyze project progress towards each of the alternative sub-projects and make recommendations on when to terminate sub-project alternatives that are no longer needed (because another superior alternative has completed), to add resources to accelerate alternatives that do not appear they will complete by the planned deadline, or to terminate such alternatives if the resources are not available or too expensive. Note that the system can evaluate the potential profitability of the gains that superior alternatives will provide and weigh those gains against the development costs remaining to complete the alternative.

Given the many sub-projects that can be developed concurrently, there will be certain decision points that will depend upon the results from one or more sub-projects. Furthermore, there will be one or more other sub-projects whose continued development will be dependent upon those decision points. Such dependencies between sub-projects may need to be explicitly managed. To support that management, the project structure according to particular embodiments offers the ability to model those decision points as project milestones. Project milestones define a particular design decision to be made by a particular date. All knowledge that is required to make that decision is stated explicitly. Progress toward a milestone can then be monitored by combining the progress made on each sub-project.

For example, consider the sub-projects 340 and 360 of FIG. 5. The decision of which technology to use for the final product design affects both sub-projects. And the decision not to use a particular technology could be forced by either sub-project alone. At which point, the corresponding alternative in the other sub-project is no longer needed for the project 200; completing it would be based solely on the value of the knowledge for future projects. In this case, an explicit milestone could be used, but probably would not add too much to this example.

However, it may not make sense to have either sub-project pushing into expensive physical testing until both sub-projects have at least gotten through the much less expensive simulation verification. In that situation, the alternative sub-projects 350 and 370 could each be split into two: a simulation project and a physical testing project. Since an entity may not want to proceed with the physical testing project until both simulation projects have completed and a decision has been made that the technology will likely work, a milestone can be created.

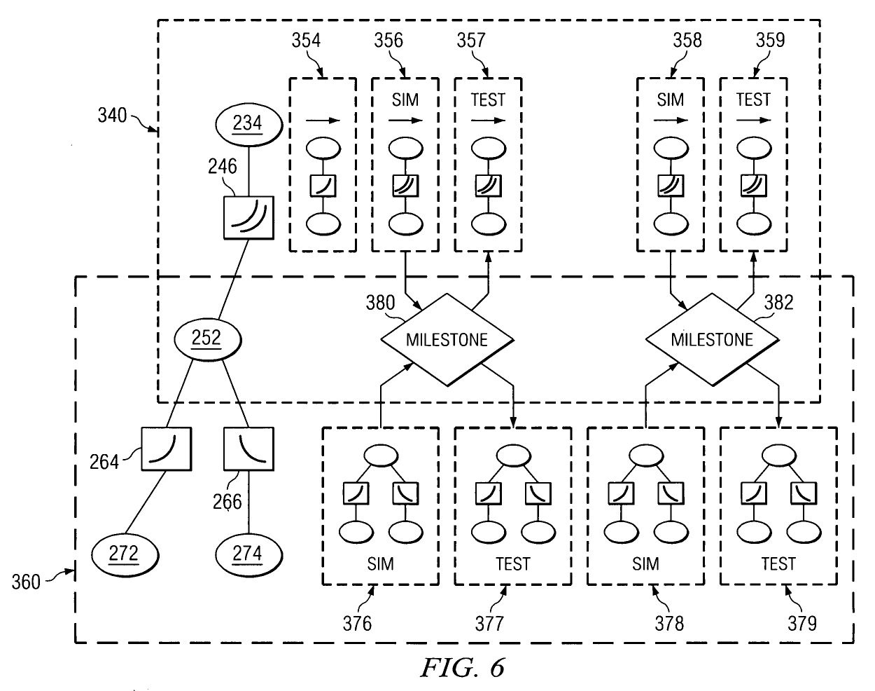

FIG. 6 illustrates further details of sub-projects 340 and 360 of project structure 200 illustrated in FIG. 5. Sub-projects 340 and 360 each include several additional sub-projects 356-359 and 376-379. Some of these sub-projects are associated with simulation, while others are associated with testing. A milestone 380 is created that is dependent upon both simulation sub-projects 356 and 376. Testing sub-projects 357 and 377 would then be dependent upon an affirmative completion of the Milestone 380 (the decision to go forward was made). A similar association could be created for sub-projects 352 and 372, resulting in the milestone 382, which is dependent on simulation sub-projects 358 and 378; and testing sub-projects 359 and 379 would be dependent upon milestone 382.

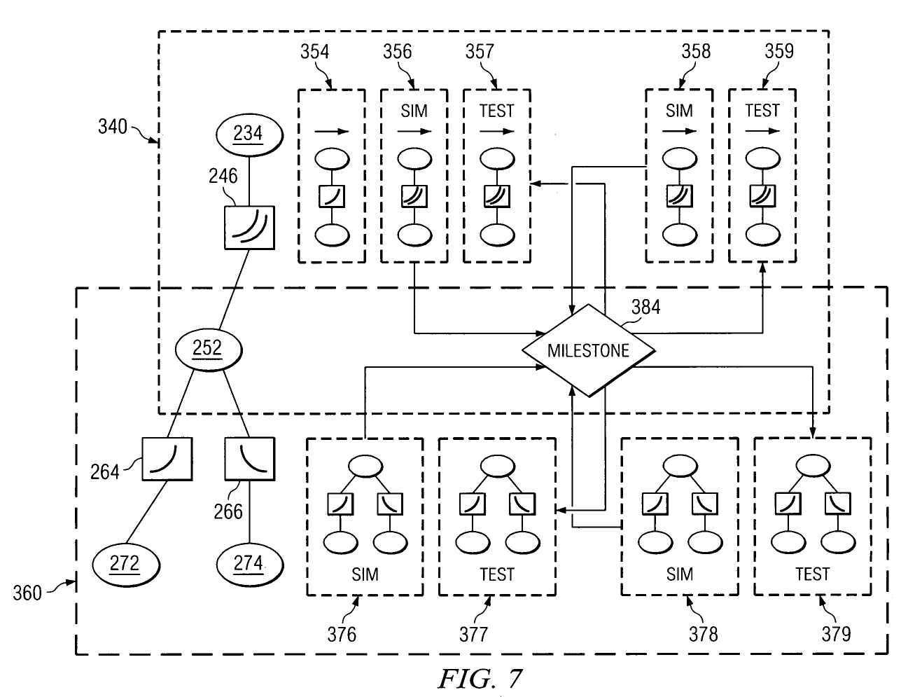

However, if physical testing is very expensive or there are not enough resources to do all of that testing by the planned completion date for the project, then an entity may instead want to complete all simulation sub-projects, and then make a single decision on which of the two technologies is best to pursue, and just pursue those two testing sub-projects. In that case, there would be only one milestone, as depicted in FIG. 7. Milestone 384 of FIG. 7 is dependent upon all four of the simulation sub-projects 356, 358, 376, and 378. All of the testing sub-projects 357, 359, 377, and 379 are thus dependent upon milestone 384.

In a more general context, the system can actively analyze the risk of the individual sub-projects and perform the statistical computations to determine the overall project risk. In that way, engineers and project managers can be given visibility to their current risk levels and can take action to reduce those risks. Similarly, the system can analyze the relative costs and relative profit potential of various sub-projects and provide tools to help the engineers and/or project managers understand the trade-offs, and optimize future value that will likely be delivered by the project, based on the risks and dollars. Finally, the system can help the engineers and project managers to determine milestones to introduce in order to further reduce risk and/or optimize value delivered by the project.

In certain cases, there is no need to wait until milestones are reached to terminate alternatives. If any alternative sub-project completes with a result superior to the optimal result of another alternative sub-project, then there is no reason to continue with that alternate sub-project for a project. Thus, continuation would be solely for knowledge generation for future projects. Similarly, if it becomes clear that this sub-project will not be completed prior to the milestone(s) that it feeds, then the choice should be made either to accelerate it, to cancel it, or to continue it solely for knowledge generation. Since either of those decisions to terminate sub-projects can be made as soon as those conditions appear, the system may provide tools to monitor and detect those conditions. Further, when an alternative sub-project is terminated, that may render other related alternatives as no longer relevant. All such dependencies between projects may be represented by the software system, such that such dependencies can be reviewed when making the termination decision, and such that those dependent projects can be terminated as well.

Furthermore, as superior alternatives are verified possible by new knowledge, the allowed ranges of other sub-assemblies may become broader, possibly falling back into already confident relations. Once again, that provides the option to kill the sub-project or let it run simply for further knowledge generation. Finally, the planned completion dates for sub-projects and the dates for milestones may be set specifically to minimize how much work is applied to sub-projects that may be able to be terminated early.

Although the present invention has been described with several embodiments, a plethora of changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. Product development software embodied in a computer-readable medium and, when executed using a computer system, operable to:
enable a user to define a product family design structure, the product family design structure comprising a plurality of customer concerns, a plurality of physical properties associated with components of the product, and a plurality of relation models, each customer concern being associated with at least one physical property via at least one mathematical relationship defined in at least one of the relation models;
enable the user to define one or more product development projects based on the product family design structure, the one or more product development projects each comprising a plurality of customer concerns, a plurality of physical properties associated with components of the product, and a plurality of relation models, each customer concern being associated with at least one physical property via at least one mathematical relationship defined in at least one of the relation models, wherein the one or more product development projects vary from the product family design structure according to one or more overrides specified by the user for the values associated with one or more of the customer concerns, relation models, and/or physical properties defined in the product family design structure;
enable the user to input a value associated with one or more of the physical properties of at least one of the product development projects; and
calculate, using one or more of the relation models, the effect of the inputted value associated with the one or more physical properties on one or more of the customer concerns of the product development project.

2. The software of claim 1, further operable to enable the user to eliminate, from at least one of the product development projects, one or more customer concerns, relation models, and/or physical properties defined in the product family design structure that are irrelevant to the product development project.

3. The software of claim 1, further operable to enable the user to define, for at least one of the product development projects, one or more sub-projects that represent a subset of the overall project and that each include one or more of a planned completion date, specific assigned resources, a duration, resource usage, and/or specific goals.

4. The software of claim 1, further operable to enable the user to specify a set of target ranges for one or more of the customer concerns of a product development project, and based on those ranges to compute possible ranges for one or more of the physical properties of the product development project.

5. The software of claim 4, further operable to eliminate relation models and physical properties from the product development project based on the lack of impact to the values of the customer concerns in the specified target ranges.

6. The software of claim 4, further operable to compute knowledge gaps, wherein knowledge gaps are defined as instances where a target range for a customer concern or a computed range for a physical property of a product development project overlap with a portion of a relation model that has a confidence level less than one hundred percent.

7. The software of claim 4, further operable to enable the user to specify a set of ranges of allowed values for one or more of the physical properties of the product development project, and based on those ranges compute possible ranges for one or more of the other physical properties and one or more of the customer concerns of the product development project.

8. The software of claim 7, further operable eliminate relation models and physical properties of the product development project based on the lack of impact to the values of the customer concerns in the specified target ranges, given the specified ranges of the other physical properties and customer concerns.

9. The software of claim 7, further operable to compute knowledge gaps, wherein knowledge gaps are defined as instances where a target range for a customer concern or a computed range for a physical property of a product development project overlap with a portion of a relation model that has a confidence level less than one hundred percent.

10. The software of claim 7, further operable to enable the user to define sub-projects within a product development project that have one or more associated tasks, each task having a planned duration and resource assignments.

11. The software of claim 7, further operable to:
enable the user to define sub-projects within a product development project that have one or more associated tasks, each task having a planned duration and resource assignments; and
compute knowledge gaps, wherein knowledge gaps are defined as instances where a target range for a customer concern or a computed range for a physical property of a product development project overlap with a portion of a relation model that has a confidence level less than one hundred percent, and wherein one or more knowledge gaps are associated with a set of tasks to be completed to fill the one or more knowledge gaps.

12. The software of claim 11, further operable to monitor progress of a product development project based on the ranges and confidence levels of the relation models and physical properties, reflecting the degree to which the knowledge gaps have been closed or eliminated.

13. The software of claim 11, further operable to relate the potential profits as described in one or more profit models associated with one or more of the customer concerns and/or one or more of the physical properties to the costs of one or more resources performing the tasks required by the project.

14. The software of claim 11, further operable to enable the user to define one or more milestones each representing one or more decisions to be made based on a set of knowledge that is determined by a set of tasks associated with certain sub-projects, wherein other sub-projects are dependent upon the completion of those milestones for their own progress.

15. The software of claim 14, further operable to compute progress towards a milestone as a percentage of the set of knowledge acquired for making the decisions to complete the milestone.

16. The software of claim 15, further operable to make resource assignment decisions based on the relative progress of different sub-projects towards their associated milestones.

17. The software of claim 15, further operable to capture rates of learning for one or more product development projects and to base expectations for rates of learning for one or more subsequent product development projects on the captured rates.

18. The software of claim 7, further operable to enable the user to define sub-projects within a product development project and allow values for one or more physical properties and/or customer concerns of one or more sub-projects to override associated values from the product family design structure by narrowing the values.

19. The software of claim 18, further operable to provide a plurality of alternative sub-projects, wherein each alternative sub-project represents a different way to reach a desired result.

20. The software of claim 19, further operable to recommend termination of a first alternative sub-project based on the progress of a second alternative sub-project when the second alternative sub-project either produces a result superior to any possible result of the first alternative sub-project or produces a result that makes one or more targets of the first sub-project no longer needed.

21. The software of claim 20, further operable to analyze a risk of a project based on the risk of its sub-projects.

22. A product development method comprising:
defining a product family design structure, the product family design structure comprising a plurality of customer concerns, a plurality of physical properties associated with components of the product, and a plurality of relation models, each customer concern being associated with at least one physical property via at least one mathematical relationship defined in at least one of the relation models;
defining one or more product development projects based on the product family design structure, the one or more product development projects each comprising a plurality of customer concerns, a plurality of physical properties associated with components of the product, and a plurality of relation models, each customer concern being associated with at least one physical property via at least one mathematical relationship defined in at least one of the relation models, wherein the one or more product development projects vary from the product family design structure according to one or more specified overrides for the values associated with one or more of the customer concerns, relation models, and/or physical properties defined in the product family design structure;
specifying a value associated with one or more of the physical properties of at least one of the product development projects; and
calculating, using one or more of the relation models, the effect of the specified value associated with the one or more physical properties on one or more of the customer concerns of the product development project.

23. The method of claim 22, further comprising eliminating, from at least one of the product development projects, one or more customer concerns, relation models, and/or physical properties defined in the product family design structure that are irrelevant to the product development project.

24. The method of claim 22, further comprising defining, for at least one of the product development projects, one or more sub-projects that represent a subset of the overall project and that each include one or more of a planned completion date, specific assigned resources, a duration, resource usage, and/or specific goals.

25. The method of claim 22, further comprising specifying a set of target ranges for one or more of the customer concerns of a product development project, and based on those ranges to compute possible ranges for one or more of the physical properties of the product development project.

26. The method of claim 25, further comprising eliminating relation models and physical properties from the product development project based on the lack of impact to the values of the customer concerns in the specified target ranges.

27. The method of claim 25, further comprising computing knowledge gaps, wherein knowledge gaps are defined as instances where a target range for a customer concern or a computed range for a physical property of a product development project overlap with a portion of a relation model that has a confidence level less than one hundred percent.

28. The method of claim 25, further comprising specifying a set of ranges of allowed values for one or more of the physical properties of the product development project, and based on those ranges compute possible ranges for one or more of the other physical properties and one or more of the customer concerns of the product development project.

29. The method of claim 28, further comprising eliminate relation models and physical properties of the product development project based on the lack of impact to the values of the customer concerns in the specified target ranges, given the specified ranges of the other physical properties and customer concerns.

30. The method of claim 28, further comprising computing knowledge gaps, wherein knowledge gaps are defined as instances where a target range for a customer concern or a computed range for a physical property of a product development project overlap with a portion of a relation model that has a confidence level less than one hundred percent.

31. The method of claim 28, further comprising defining sub-projects within a product development project that have one or more associated tasks, each task having a planned duration and resource assignments.

32. The method of claim 28, further comprising:
defining sub-projects within a product development project that have one or more associated tasks, each task having a planned duration and resource assignments; and
computing knowledge gaps, wherein knowledge gaps are defined as instances where a target range for a customer concern or a computed range for a physical property of a product development project overlap with a portion of a relation model that has a confidence level less than one hundred percent, and wherein one or more knowledge gaps are associated with a set of tasks to be completed to fill the one or more knowledge gaps.

33. The method of claim 32, further comprising monitoring progress of a product development project based on the ranges and confidence levels of the relation models and physical properties, reflecting the degree to which the knowledge gaps have been closed or eliminated.

34. The method of claim 32, further comprising relating the potential profits as described in one or more profit models associated with one or more of the customer concerns and/or one or more of the physical properties to the costs of one or more resources performing the tasks required by the project.

35. The method of claim 32, further comprising defining one or more milestones each representing one or more decisions to be made based on a set of knowledge that is determined by a set of tasks associated with certain sub-projects, wherein other sub-projects are dependent upon the completion of those milestones for their own progress.

36. The method of claim 35, further comprising compute progress towards a milestone as a percentage of the set of knowledge acquired for making the decisions to complete the milestone.

37. The method of claim 36, further comprising making resource assignment decisions based on the relative progress of different sub-projects towards their associated milestones.

38. The method of claim 36, further comprising capturing rates of learning for one or more product development projects and to base expectations for rates of learning for one or more subsequent product development projects on the captured rates.

39. The method of claim 28, further comprising defining sub-projects within a product development project and allow values for one or more physical properties and/or customer concerns of one or more sub-projects to override associated values from the product family design structure by narrowing the values.

40. The method of claim 39, further comprising providing a plurality of alternative sub-projects, wherein each alternative sub-project represents a different way to reach a desired result.

41. The method of claim 40, further comprising terminating a first alternative sub-project based on the progress of a second alternative sub-project when the second alternative sub-project either produces a result superior to any possible result of the first alternative sub-project or produces a result that makes one or more targets of the first sub-project no longer needed.

42. The method of claim 41, further comprising analyzing a risk of a project based on the risk of its sub-projects.
